(19) United States
(12) Patent Application Publication
(10) Pub. No.: US 2010/0077044 A1
(43) Pub. Date: Mar. 25, 2010

(54) MOBILE COMMUNICATION APPARATUS

(75) Inventor: Masatoshi TSUBOUCHI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/563,402

(22) Filed: Sep. 21, 2009

(30) Foreign Application Priority Data
Sep. 22, 2008 (JP) 2008-243416

(51) Int. Cl. G06F 15/16

(52) U.S. Cl. 709/206; 709/217

(57) ABSTRACT

A controller of a mobile communication apparatus, such as a cellular phone, that detects whether an external apparatus is connected to an interface, and transmits an email received from a base station to the external apparatus when the external apparatus is connected to the interface. The controller of the mobile communication apparatus also sets an email address of the mobile communication apparatus to a sender address of an email created by the external apparatus connected to the interface, and transfers the email created by the external apparatus to a base station.

### CROSS-REFERENCE TO RELATED APPLICATIONS

This application is based upon and claims the benefit of priority from prior Japanese Patent Application No. 2008-243416, filed Sep. 22, 2008, the entire contents of which are incorporated herein by reference.

### BACKGROUND OF THE INVENTION

1. Field of the Invention

The present invention relates to a mobile communication apparatus, which is connectable to an information processing apparatus and cooperates with the information processing apparatus to handle an email.

2. Description of the Related Art

Generally, a mobile communication apparatus, such as a cellular phone, and a personal computer have an email function. For example, Jpn. Pat. Appln. KOKAI Publication No. 2003-131989 (Sakai et al.) shows that an email created on a personal computer can be handled by a cellular phone.

However, the publication does not consider reading an email received by a cellular phone on a display of a personal computer or creating a reply email to the email received by the cellular phone on the personal computer with a simple manipulation.

### BRIEF SUMMARY OF THE INVENTION

Exemplary embodiments of the present invention provide an information processing apparatus which transmits an email to a display of an external apparatus so that a user can read the email on the external apparatus and sets an email address of the mobile communication apparatus to a sender address of an email, which is created on the external apparatus, as if the email is sent from the mobile communication apparatus. The present invention is not limited to an information processing apparatus that includes all of these features.

According to one aspect of the present invention an information processing apparatus includes: a first interface configured to communicate with a base station; a second interface configured to communicate with an external apparatus; a memory configured to store emails; a controller configured to detect whether the external apparatus is connected to the second interface, and transfer an email received via the first interface to the external apparatus automatically when it is detected that the external apparatus is connected to the second interface.

### BRIEF DESCRIPTION OF THE SEVERAL VIEWS OF THE DRAWING

The accompanying drawings, which are incorporated in and constitute a part of the specification, illustrate exemplary embodiments of the invention, and together with the general description given above and the detailed description of the exemplary embodiments given below, serve to explain the principles of the invention.

FIG. 1 is a functional block diagram of a cellular phone and a personal computer;

FIGS. 2A and 2B are examples of a mail creation screen on a display unit of the personal computer;

FIG. 3 is another example of a mail creation screen on a display unit of the personal computer;

FIG. 4 is a block diagram of the cellular phone;

FIG. 5 is a block diagram of the personal computer;

FIG. 6 is a flowchart for explaining a mode switching process performed by the cellular phone;

FIG. 7 is a flowchart for explaining an email reception process performed by the cellular phone; and

FIG. 8 is a flowchart for explaining an email creation process performed by the personal computer.

### DETAILED DESCRIPTION OF THE INVENTION

Exemplary embodiments of the present invention will be described hereinafter with reference to the accompanying drawings.

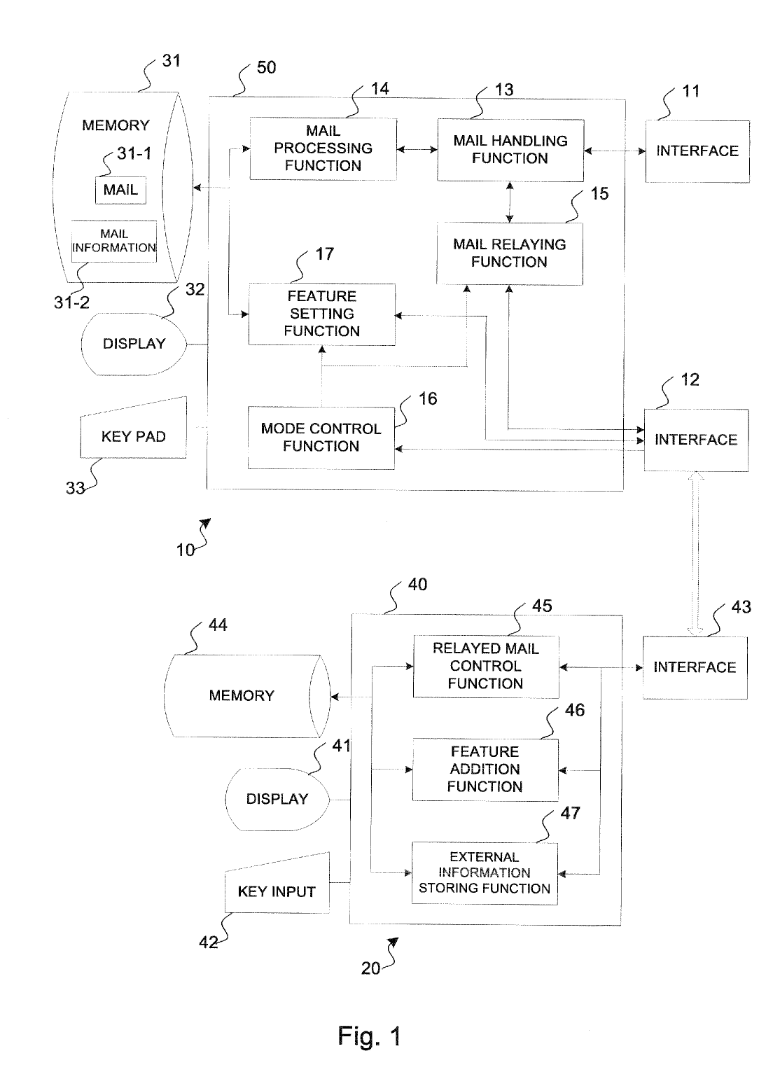

FIG. 1 shows an exemplary system composition which includes a cellular phone 10 and a personal computer 20. The cellular phone 10 and the personal computer 20 can communicate via a cable or a wireless link, such as Bluetooth® or infrared communication.

FIG. 1 also shows functional blocks installed in the cellular phone 10 and the personal computer 20.

The cellular phone 10 is equipped with a first interface 11 for communicating with a base station in a cellular phone network, a second interface 12, such as a Bluetooth® circuit or an infrared communication circuit, for communicating with an external device, such as the personal computer 20, a memory unit 31 including a mail storing area 31-1 and a mail information storing area 31-2, a display unit 32 such as an LCD (Liquid Crystal Display), key pad 33 having a plurality of keys, and a control unit 50. The control unit 50 has a mail handling function 13, a mail processing function 14, a mail relaying function 15, a mode control function 16, and a feature setting function 17. These functions 13 through 17 may be realized by executing software stored in the memory unit 31.

The mail handling function 13 is a function to transmit and receive an email to and from the base station via the first interface 11.

The mail processing function 14 is a function to display a mail creation screen on the display unit 32 in response to an instruction inputted via the key pad 33. For example, the instruction for displaying the mail creation screen can be inputted by depressing a mail key on the key pad 33 or selecting a mail menu from a menu list displayed on the display unit 32. Also, the mail processing function 14 instructs the mail handling function 13 transmit an email created by using the key pad 33 to the base station via the first interface 11, and stores a received email into the mail storing area 31-1.

The mail relaying function 15 transfers an email received from the personal computer 20 to the base station via the first interface 11 when the cellular phone is in a transfer mode.

The mode control function 16 is a function to set one of a normal mode, a synchronizing mode, and a transfer mode. The mode determined by the mode control function 16 is transmitted to the mail relaying function 15 and the feature setting function 17. The mode control function 16 sets the normal mode when no external device, whose identification information is stored in the memory unit 31, is connected to the second interface 12. The mode control function 16 sets the synchronizing mode when an external device, whose identification information is stored in the memory unit 31, is connected to the second interface 12 but the same information stored in the mail information storing area 31-2 is not stored in the external device. And the mode control function 16 sets the transfer mode when an external device, whose identification information is stored in the memory unit 31, is connected to the second interface 12 and the same information stored in the mail information storing area 31-2 is stored in the external device.

The feature setting function 17 is a function to transmit phonebook information, including a plurality of sets of a telephone number, an email address, and a name, pictographic information, and picture information stored in the mail information storing area 31-2 to an external device via the second interface 12 when the mode control function 16 informs the feature setting function 17 that the operation mode is the synchronizing mode. However, the feature setting function 17 may not transmit the phonebook information, pictographic information, or picture information if there is no change in the mail information storing area 31-2 after the previous transmission of the phonebook information, pictographic information, or the picture information. In this case, the memory unit 31 stores identification information of an external device and information to identify a difference between the phonebook information, the pictographic information, or the picture information currently stored in the mail information storing area 31-2 and the previously transmitted phonebook information, pictographic information, or picture information.

The mail relaying function 15 is also a function to transfer a received email from the base station to the external device, such as the personal computer 20, connected to the second interface 12 when the synchronizing mode is set.

The personal computer 20 has a central processing unit 40 composed of a processor and a main memory, a display unit 41, a key input device 42 for inputting data and commands, a third interface 43 for communicating with an external device, such as a cellular phone 10, and a memory unit 44 for storing received emails, phonebook information, pictographic information, and picture information received from the external device and so on. The memory unit 44 may be a Hard Disk Drive (HDD).

The central processing unit 40 has a relayed mail control function 45, a feature addition function 46, and an external information storing function 47. The relayed mail control function 45, the feature addition function 46, and the external information storing function 47 may be realized by executing software that is stored in the memory unit 44.

The relayed mail control function 45 is a function to store an email received from the cellular phone 10 via the third interface 43 into the memory unit 44 and display an email stored in the memory unit 44 on the display unit 41 in response to an instruction input via the key input device 42.

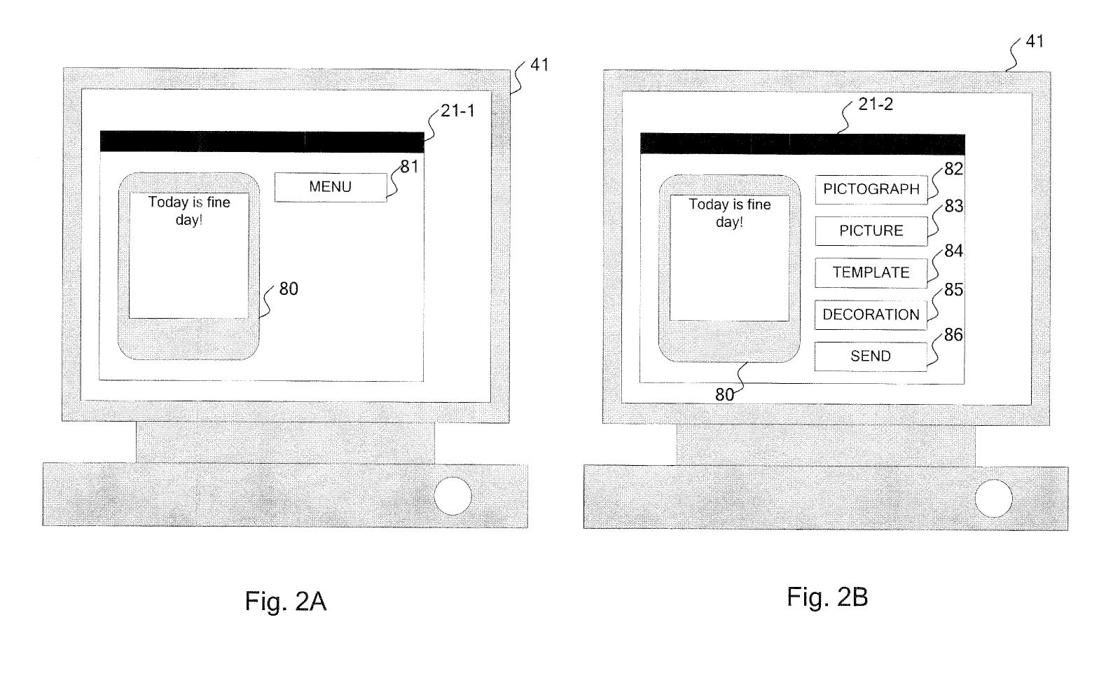

The feature addition function 46 is a function to realize an email creation condition similar to that in a cellular phone 10. For example, an icon for displaying an email creation screen is displayed on the display unit 41. This icon may be displayed on the display unit 41 only when a cellular phone 10 is connected via the third interface 43. When a user clicks or double-clicks the icon, an email creation screen is displayed on the display unit 41. As shown in FIG. 2A, the email creation screen 21-1 includes a message input area 80, which is an image of a display screen of a cellular phone, and a menu icon 81. When the user clicks or double-clicks the menu icon 81, as shown in FIG. 2B, a pictograph icon 82, an image icon 83, a template icon 89, a decoration icon 85, and a send icon 86 are displayed in the email creation screen 21-2 on the display unit 41.

When the pictograph icon 82 is selected by manipulating a mouse of the personal computer 20, a pictograph list window including a plurality of pictographs is displayed on the display unit 41 so that the user can select a pictograph (s) from the list. When the image icon 83 is selected by manipulating the mouse, a picture list window including a plurality of pictures is displayed on the display unit 41 so that the user can select a picture (s) to be attached an email. When the template icon 84 is selected by manipulating the mouse, a mail template list window including a plurality of mail templates is displayed on the display unit 41 so that the user can select a mail template to be used for creating an email. When the decoration icon 85 is selected by manipulating the mouse, the personal computer 20 accesses a service where characters displayed on the message input area 80 can be colored and a picture and so on can be attached to an email being created. Finally, when the send icon 86 is selected by manipulating the mouse, a created email is sent.

Also, the feature addition function 46 intermediates so that characters inputted via the key input device 42 are arranged on the message input area 80. The feature addition function 46 may display a key input screen similar to a keypad of cellular phone so that a user familiar with using a cellular phone can input characters easily by clicking buttons on the keypad on the screen. The key input device (e.g., keyboard) of the personal computer 20 may also be used to input characters.

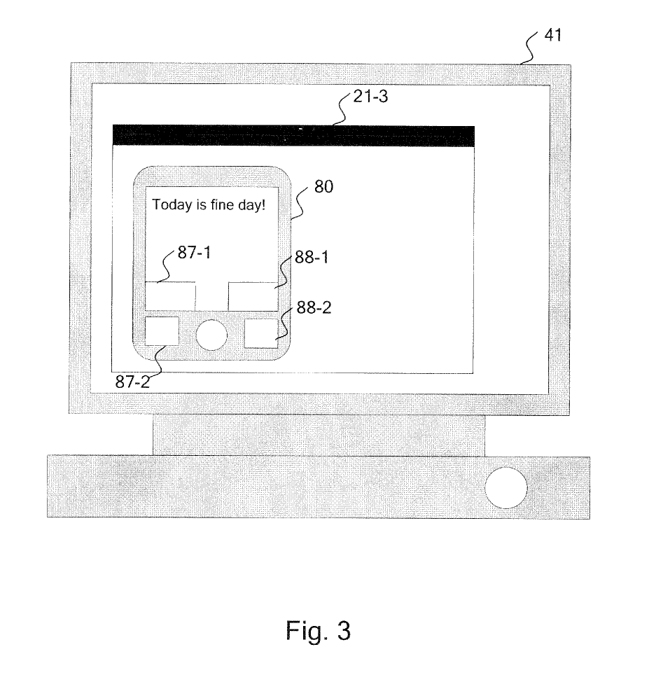

Instead of first displaying the email creation screen 21-1 when the icon for displaying the email creation screen is clicked or double-clicked and then displaying the email creation screen 21-2 when the when the user clicks or double-clicks the menu icon 81, when the icon for displaying the email creation screen is clicked or double-clicked, the mail creation screen 21-2 shown in FIG. 2B may directly be displayed on the display unit 41. Also, when the icon for displaying the email creation screen is clicked or double-clicked, a mail creation screen 21-3 shown in FIG. 3 may be displayed on the display unit 41. The mail creation screen 21-3 shown in FIG. 3 includes a message input area 80 with quasi-soft-keys 87-1 and 88-1. Also, adjacent to each of the quasi-soft-keys 87-1 and 88-1, e.g. “menu” and “range”, function-keys 87-2 and 88-2, e.g. “F1” and “F2”, of the key input device 42 are displayed. Therefore, in this case, the user can select functions with simple manipulations.

When an email is created by using the mail creation screens 21-1 and 22-2 as described above, under the control of the relayed mail control function 45, the email is transmitted via the third interface 43 by selecting the send icon 86 which is assigned a function to transmit an email. When an email is created by using the mail creation screen 21-3, one of the function-keys 87-2 and 88-2, to which a mail sending function is assigned, is used for sending the created email via the third interface 43. The email transmitted to the cellular phone 10 via the third interface 43 contains a receiver's email address and a flag indicating that the email is relayed by the cellular phone 10. When the mail relay function 15 receives the email containing the flag via the second interface 12, the mail relay function 15 sets an email address of the cellular phone 10 as a sender email address in the received email. Thereafter, the mail relay function 15 transfers the email to the mail handling function 13.

The external information storing function 47 stores the phonebook information, the pictographic information, and the picture information received via the third interface 43 from the cellular phone 10 in the memory unit 44. The phonebook information, the pictographic information, and the picture information are transmitted from the cellular phone 10 when the cellular phone is in the synchronizing mode. The phonebook information, the pictographic information, and the picture information are referred to by the feature addition function 46 when an email is created.

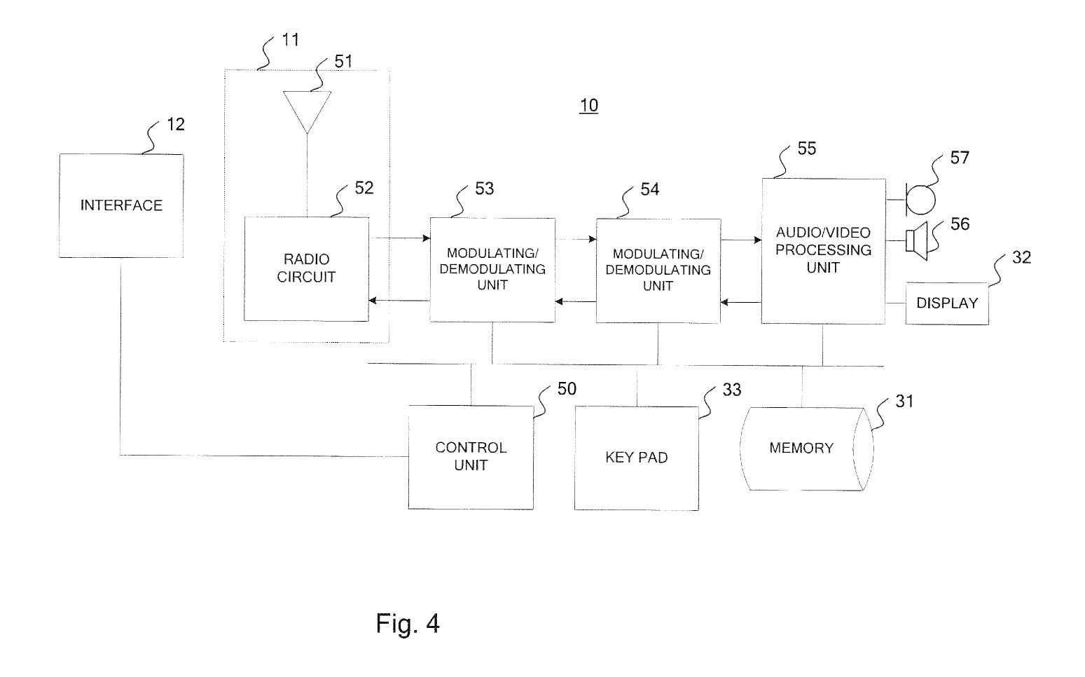

An exemplary composition of the cellular phone 10 is shown in FIG. 4. As shown in FIG. 4, the cellular phone 10 includes an antenna 51, a radio circuit 52, a modulating/demodulating unit 53, a multiplexing/de-multiplexing unit 54, an audio/video processing unit 55, a speaker 56, and a microphone 57. Needless to say, the cellular phone 10 includes the display unit 32, the key pad 33, and the control unit 50, as are shown in FIG. 1. The cellular phone 10 also includes the interfaces 11 and 12, as are shown in FIG. 1. As shown in FIG. 4, the antenna 51 and the radio circuit 52 form the first interface 11.

Radio signals transmitted from a base station are received by the radio circuit 52 via the antenna 51. The radio circuit 52 down-converts the received radio signals and generates down-converted radio signals. The down-converted radio signals are inputted into the modulating/demodulating unit 53. The modulating/demodulating unit 53 demodulates the down-converted radio signals and generates packet data. The packet data is inputted into the multiplexing/de-multiplexing unit 54. When the multiplexing/dc-multiplexing unit 54 receives the packet data, the multiplexing/de-multiplexing unit 54 de-multiplexes the packet data into coded audio data, coded video data, control data, and so on. Thereafter, the coded audio data and the coded video data are inputted into the audio/video processing unit 55, and the control data is inputted into the control unit 50. The coded audio data and the coded video data are respectively decoded by the audio/video processing unit 55 and audio data and video data are generated. The audio data is outputted from the speaker 56 and the video data is displayed on the display unit 32.

On the other hand, a user's voice captured by the microphone 57 is inputted into the audio/video processing unit 55 and converted into the coded audio data. Thereafter, the coded audio data is multiplexed with coded video data, email data, control data, and so on in the multiplexing/de-multiplexing unit 54 and packet data is generated. The packet data is modulated by the modulating/demodulating unit 53 and modulated signals are generated. The modulated signals are up-converted by the radio circuit 52 and transmitted to the base station via the antenna 51 as radio signals.

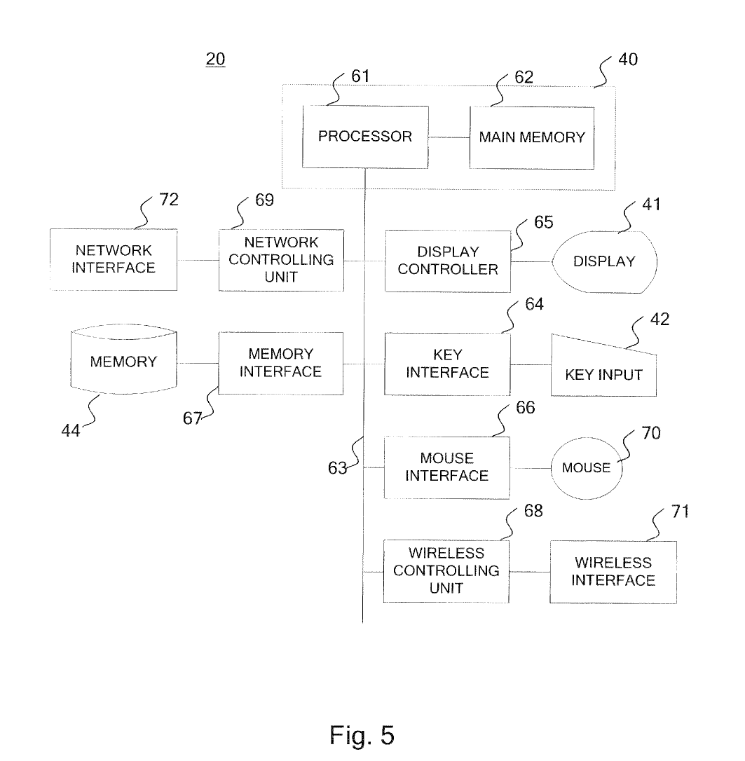

An exemplary composition of the personal computer 20 is shown in FIG. 5. As shown in FIG. 5, the personal computer 20 includes a processor 61 and a main memory 62 corresponding to the central processing unit 40 in FIG. 1, a key interface 64 for receiving key input signals from the key input device 42, a display controller 65 for displaying information on the display unit 41, a mouse interface 66 for receiving mouse input signals from a mouse 70, and memory interface 67 for communicating with the memory unit 44. Also, the personal computer 20 includes a wireless controlling unit 68 and a wireless interface 71 corresponding to the third interface 43, and a network controlling unit 69 and a network interface 72. The processor 61, the key interface 64, the display controller 65, the mouse interface 66, the memory interface 67, the wireless controlling unit 68, and the network controlling unit 69 are connected to a system bus 63.

The network controlling unit 69 and the network interface 72 are used when the personal computer 20 communicates with another personal computer or accesses a server computer without using the cellular phone 10.

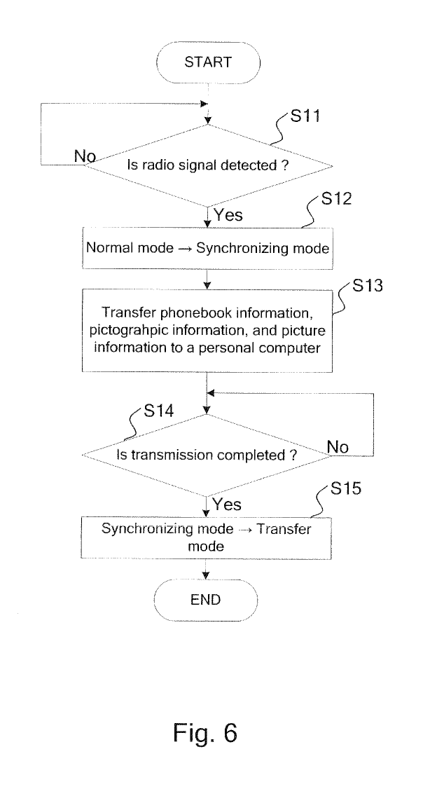

Hereinafter, with reference to FIG. 6, a mode switching process performed by the cellular phone 10 will be explained.

in step S11, the mode control function 16 checks a short-range radio signal received via the second interface 12. In this case, a power level of the short-range radio signal and identification information contained in the short-range radio signal is checked. When the mode control function 16 detects that the power level satisfies a predetermined level and there is identification information in the memory unit 31 that coincides with the received identification information, the mode control function 16 detects that an allowable external device is present in an effective range, and then switches an operation mode from the normal mode to the synchronizing mode, in step S12. In this example, the personal computer 20 is the allowable external device.

When the synchronizing mode is set as the operation mode, the mode control function 16 informs the feature setting function 17 that the operation mode has changed to the synchronizing mode. Then, the feature setting function 17 transmits phonebook information, pictographic information, and picture information in the mail information storing area 31-2 to the personal computer 20 via the second interface 12 so as to synchronize the phonebook information, the pictographic information, and the picture information in the mail information storing area 31-2 with those in the memory unit 44, in step S13. When the feature setting function 17 completes transmitting the phonebook information, the pictographic information, and the picture information to the personal computer 20, in step S14, the mode control function 16 switches the operation mode from the synchronizing mode the transfer mode, in step S15.

In steps S14 and S15, the mode control function 16 switches the operation mode when the feature setting function 17 completes the transmission of the phonebook information, the pictographic information, and the picture information to the personal computer 20. However, if the personal computer 20 has a function to send a signal indicating that the phonebook information, the pictographic information, and the picture information has been updated, the mode control function switches the operation mode in response to reception of that signal.

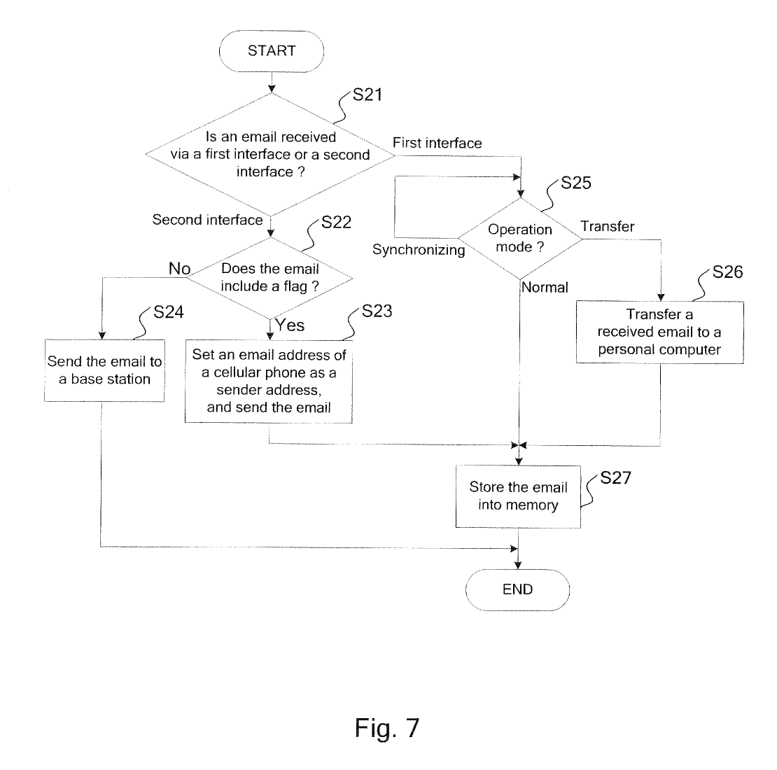

Next, with reference to FIG. 7, an email reception process performed by the cellular phone 10 will be explained.

In step 21, when an email is received, the control unit 50 checks whether the email was received via the first interface 11 or via the second interface 12. If the email was received via the second interface 12, then the mail relaying function 15 checks whether the email includes the flag indicating that the email is to be relayed by the cellular phone 10, in step S22. If the email includes the flag, the mail relaying function 15 sets an email address of the cellular phone 10 into the sender address of the email and transfers the email to the mail handling function 13. Thereafter, the mail handling function 13 transmits the email to the base station via the first interface 11, in step S23. On the other hand, if the email does not include the flag, the mail relaying function 15 simply transfers the email to the mail handling function 13. Thereafter, the mail handling function 13 transmits the email to the base station via the first interface 11, in step S24.

If, in step S21, it is detected that the email is received via the first interface 11 and mail handling function 13, the mail relaying function 15 checks a present operation mode, in step S25. If it is detected that the present operation mode is the normal mode, the mail relaying function 15 does not transfer the email, and the mail handling function 13 transfers the email to the mail processing function 14 so as to store the email in the mail storing area 31-1 by the mail processing function 14. If, in step S25, it is detected that the present operation mode is the synchronizing mode, the mail relaying function 15 waits for the operation mode to be switched to the transfer mode. Furthermore, if, in step S25, it is detected that the present operation mode is the transfer mode, the mail relaying function 15 transfers the received email to the personal computer 20 via the second interface 12, in step S26. In this case, the mail relaying function 15 adds a flag indicating that the email is transferred but does not add “FW:” before the subject of the email.

In step S27, when the mail handling function 13 transfers the received email via the first interface 11 in step S23 or the mail relaying function 15 in step S26, the mail handling function 13 transfers the email to the mail processing function 14 so as to store the email in the mail storing area 31-1 by the mail processing function 14. Also, if the email contains the flag indicating that the email is relayed by the cellular phone 10, the mail handling function 13 transfers the email with the flag to the mail processing function 14. Thus, the email stored in the mail storing area 31-1 contains the flag if the email is received from the personal computer 20 and transferred by the mail relaying function 15, the user easily recognizes that the mail is created by the personal computer 20 but includes the email address of the cellular phone 10 as a sender address.

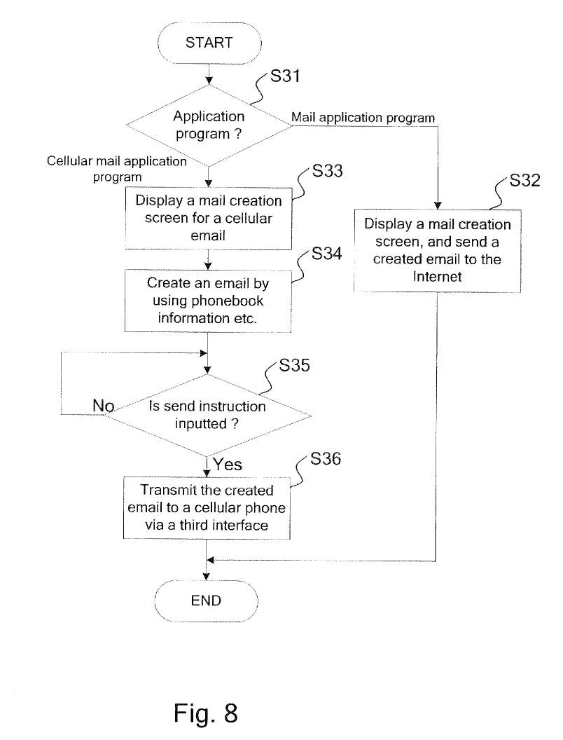

Next, with reference to FIG. 8, an email creation process performed by the personal computer 20 will be explained.

In step S31, the central processing unit 40 checks whether a mail application program is selected or a cellular mail application program is selected by using the key input device 42. When the central processing unit 40 detects that the mail application program is selected, a mail creation screen for creating an email is displayed on the display unit 41 and created email is sent to the Internet, via the network controlling unit 69 and the network interface 72, in step S32. It is obvious that a personal computer can transmit and receive data to and from other personal computers or a server via a cellular phone to which the personal computer is connected. Therefore, if the mail application program is selected when the network controlling unit 69 and the network interface 72 are not available but the cellular phone 10 is connected to the third interface 43, the email created on the mail application program can be transmitted to the Internet via the third interface 43 and the cellular phone 10. In this case, no flag is added to the email.

On the other hand, when the central processing unit 40 detects that the cellular mail application program is selected, the feature addition function 46 displays the mail creation screen 21-1, the mail creation screen 21-2, or the mail creation screen 21-3 on the display unit 41, in step S33. In this case, the feature addition function 46 refers to the phonebook information, the pictographic information, and the picture information stored in the memory unit 44.

In step S34, the user creates an email by inputting a message and selecting a receiver's email which is read out from the phonebook information in the memory unit 44 (or input as a new email address not stored in the phonebook information). While the mail creation screen 21-1, the mail creation screen 21-2, or the mail creation screen 21-3 is displayed on the display unit 41, the central processing unit 40 awaits a mail send instruction input via the key input device 42, in step S35. As described above, when the mail creation screen 21-2 is displayed, the send icon 86 is used for sending a created email. Also, when the mail creation screen 21-3 is displayed, one of the function-keys 87-2 and 88-2, to which a mail sending function is assigned, is used for sending the created email.

When an instruction for sending the created email is received, the central processing unit 40 sends the created email to the cellular phone 10 via the third interface 43, in step S36. In this case, the central processing unit 40 puts the flag indicating that the email is to be relayed by the cellular phone 10 in the created email. Also, the created email includes a receiver's address selected from the phonebook information in the memory unit 44 and may include a symbol, “Re” showing a return email, before a subject of the created email if the email is being sent in reply to a received email.

What is claimed is:

1. A mobile communication apparatus, comprising:
a first inter configured to communicate with a base station;
a second interface configured to communicate with an external apparatus;
a memory configured to store emails;
a controller configured to detect whether the external apparatus is connected to the second interface, and transfer an email received via the first interface to the external apparatus automatically when it is detected that the external apparatus is connected to the second interface.

2. The mobile communication apparatus according to claim 1, wherein the memory is further configured to store phonebook information, and the controller is further configured to transmit the phonebook information to the external apparatus when it is detected that the external apparatus is connected to the second interface.

3. The mobile communication apparatus according to claim 1, wherein the controller is further configured to set an email address of the mobile communication apparatus as a sender address of an email received from the external apparatus connected to the second interface, and to transfer the email to the base station via the first interface.

4. The mobile communication apparatus according to claim 3, wherein the controller is further configured to store the email, which is transferred to the base station via the first interface, into the memory.

5. The mobile communication apparatus according to claim 1, wherein the memory further stores identification information, and the controller is further configured to compare identification information received from the external apparatus via the second interface with the identification information stored in the memory, and to transfer the email to the external apparatus automatically when it is detected that the external apparatus is connected to the second interface and that the identification information from the external apparatus coincides with the identification information stored in the memory.

6. A mobile communication apparatus, comprising:
a first interface configured to communicate with a base station;
a second interface configured to communicate with an external apparatus;
a memory configured to store emails;
means for detecting whether the external apparatus is connected to the second interface; and
means for transferring an email received via the first interface to the external apparatus automatically when it is detected that the external apparatus is connected to the second interface.

7. The mobile communication apparatus according to claim 6, wherein the memory is further configured to store phonebook information, and the apparatus further comprises means for transmitting the phonebook information to the external apparatus when it is detected that the external apparatus is connected to the second interface.

8. The mobile communication apparatus according to claim 6, further comprising:
means for setting an email address of the mobile communication apparatus as a sender address of an email received from the external apparatus connected to the second interface; and
means for transferring the email to the base station via the first interface.

9. The mobile communication apparatus according to claim 8, further comprising:
means for storing the email, which is transferred to the base station via the first interface, into the memory.

10. The mobile communication apparatus according to claim 6, wherein the memory further stores identification information, and the apparatus further comprises means for comparing identification information received from the external apparatus via the second interface with the identification information stored in the memory, and for transferring the email to the external apparatus automatically when it is detected that the external apparatus is connected to the second interface and that the identification information from the external apparatus coincides with the identification information stored in the memory.
